(19) United States
(12) Patent Application Publication
(10) Pub. No.: US 2007/0098956 A1
(43) Pub. Date: May 3, 2007

(54) Plastic bricks and method for making the same

(76) Inventor: Thompson Ko, Kaohsiung City (TW)

Correspondence Address: CHARLES E. BAXLEY, ESQ., 90 JOHN STREET, THIRD FLOOR, NEW YORK, NY, 10038, US

(21) Appl. No.: 11/264,533

(22) Filed: Oct. 31, 2005

(51) Int. Cl. G11B 5/64; B29C 47/06

(52) U.S. Cl. 428/141; 264/160; 264/322; 264/173.16

(57) ABSTRACT

A plastic brick includes a bottom layer with a base connected on the bottom layer, a printed plastic sheet connected on the base and a top layer connected on the printed plastic sheet. The material of the bottom layer and the base includes similar deformation efficiency and are mixed and extruded by a T-shaped cavity. The combined bottom layer and the base is then rolled, adhered with a printed plastic sheet and top layer, cooling, pre-heating, pressing patterns on the top layer, tempering and cutting into desired sizes. The plastic bricks can be made in mass production and includes sufficient thickness so as to increase the durability and term of use.

### FIELD OF THE INVENTION

The present invention relates to a plastic brick and a method for making the same. The method increases the efficiency of production and the plastic bricks are more durable and the thickness of the plastic bricks can be thicker than the conventional plastic bricks.

### BACKGROUND OF THE INVENTION

A conventional plastic brick is shown in FIG. 5 and generally includes a base 5 with a layer of printed plastic sheet 6 connected on a top of the base 5. A top layer 7 is adhered to the printed plastic sheet 6. The connection of the base 5, the printed plastic sheet 6 and the top layer 7 is made by specific machine. The base 5 is made by soft material so as to adapt the surface condition of the floor and the top layer 7 has to be stiff for bearing loads and friction. The top layer 7 tends to be deformed and curved so that the thickness of the top layer 7 has to be limited within a range. However, the thinner plastic bricks have less durability and cannot have a longer life of use. Besides, the top layer 7 is adhered to the printed plastic sheet 6 so that the top layer 7 is easily to be peeled off from the printed plastic sheet 6 when the humidity changes. Furthermore, the plastic bricks are made one by one by the machine and difficult to produce in a mass production.

The present invention intends to provide a plastic brick and a method for making the plastic brick wherein method allows the plastic bricks to be manufactured in mass production and the connection between the layers is strong.

### SUMMARY OF THE INVENTION

The present invention relates to a plastic brick which comprises a bottom layer and a base connected on the bottom layer. A printed plastic sheet is connected on the base and a top layer is connected on the printed plastic sheet. The bottom layer and the base are connected to each other by fusion. The bottom layer and the top layer have similar deformation efficiency.

The present invention also provides a method for making the plastic brick. The method includes a step of mixing material of the bottom layer and the base in two mixing devices; a step of stirring the material of the bottom layer in a stirring device and stirring the material of the base in a high speed stirring device to obtain semi-plasticized material; a step of extruding for sending the semi-plasticized material of the bottom layer and the semi-plasticized material of the base into two respective extruders to obtain two completely plasticized material; a step of extruding the two completely plasticized material into an extruder and extruded via a T-shaped cavity to combine the base and the bottom layer as a combined layer; a step of rolling the combined layer into desired thickness; a step of rolling and adhering the printed plastic sheet and the top layer to the combined layer by rolling and adhering; a step of cooling the combined bottom layer, the base, the printed plastic sheet and the top layer; a step of pre-heating the combined bottom layer, the base, the printed plastic sheet and the top layer to have a softened top surface; a step of pressing a serrated surface on the combined bottom layer, the base, the printed plastic sheet and the top layer; a step of tempering the combined bottom layer, the base, the printed plastic sheet and the top layer to release stress therein, and a step of cutting the tempered combined bottom layer, the base, the printed plastic sheet and the top layer to a complete plastic brick.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a flow chart to show the steps of the method of the present invention;

FIG. 2 shows that the combined bottom layer and the base are extruded via a T-shaped cavity;

FIG. 3 shows a printed plastic sheet and a top layer are adhered to the base;

FIG. 4 is a cross sectional view to show the plastic brick of the present invention, and

FIG. 5 shows a cross sectional view of a conventional plastic brick.

### DETAILED DESCRIPTION OF THE PREFERRED EMBODIMENT

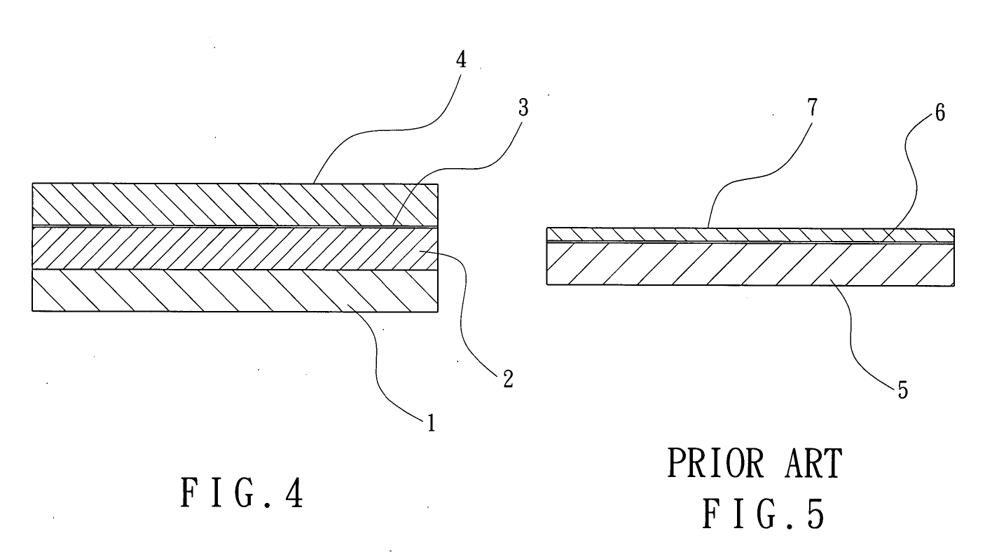

Referring to FIG. 4, the plastic brick of the present invention comprises a bottom layer 1 with a base 2 connected on the bottom layer 1, a printed plastic sheet 3 having patterns printed thereon is connected on the base 2 and a top layer 4 is connected on the printed plastic sheet 3. The bottom layer 1 and the base 2 are connected to each other by fusion so that the connection is strong and the two layers 1, 2 are not peeled from each other. The bottom layer 1 and the top layer 4 have similar deformation efficiency, and the top layer 4 has a serrated surface.

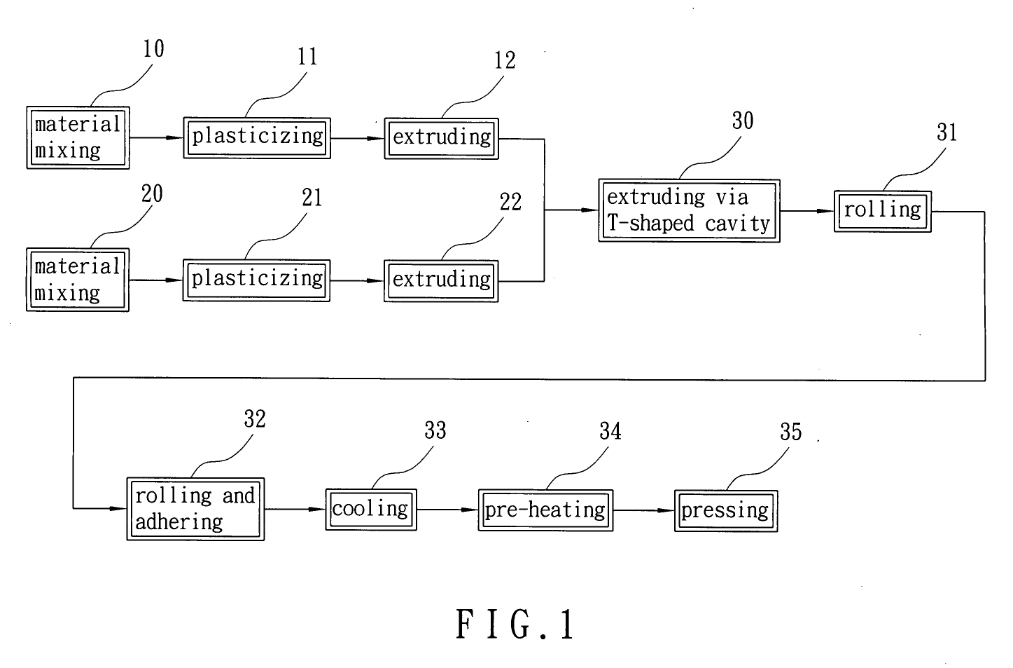

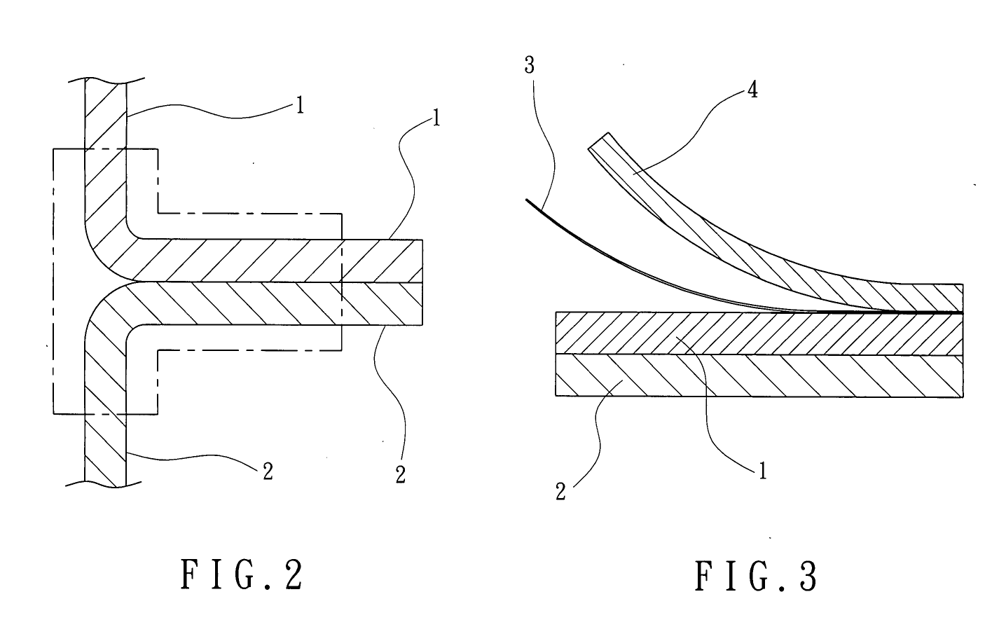

Referring to FIGS. 1 to 3, a method for making a plastic brick as mentioned above includes the following steps:

step of material mixing 10, 20: mixing material of the bottom layer 1 and the base 2 in two mixing devices;

step of plasticizing 11, 21: stirring the material of the bottom layer 1 in a stirring device and stirring the material of the base 2 in a high speed stirring device to obtain semi-plasticized material;

step of extruding 12, 22: sending the semi-plasticized material of the bottom layer 1 and the semi-plasticized material of the base 2 into two respective extruders to obtain two completely plasticized material;

step of extruding via T-shaped cavity 30: sending the two completely plasticized material into an extruder and extruded via a T-shaped cavity to combine the base 2 and the bottom layer 1 as a combined layer, the two respective contact surfaces of the base 2 and the bottom layer 1 being in a melting status so that the base 2 and the bottom layer 1 can be connected firmly;

step of rolling 31: rolling the combined layer into desired thickness;

step of rolling and adhering 32: connecting the printed plastic sheet 3 and the top layer 4 to the combined layer by rolling and adhering;

step of cooling 33: cooling the combined bottom layer 1, the base 2, the printed plastic sheet 3 and the top layer 4;

step of pre-heating 34: heating the combined bottom layer 1, the base 2, the printed plastic sheet 3 and the top layer 4 to have a softened top surface;

step of pressing 35: pressing a serrated surface on the combined bottom layer 1, the base 2, the printed plastic sheet 3 and the top layer 4;

step of tempering: treating the combined bottom layer 1, the base 2, the printed plastic sheet 3 and the top layer 4 with tempering to release stress therein, and

step of cutting: cutting the tempered combined bottom layer 1, the base 2, the printed plastic sheet 3 and the top layer 4 to a complete plastic brick.

Before the step of rolling and adhering 32, a step of heating can be applied to soften the adhering surfaces of the base 2 so that the printed plastic sheet 3 is firmly and easily adhered to the base 2. A step of expanding to remove wrinkles on the printed plastic sheet 3 and the top layer 4 is applied before the step of rolling and adhering such that the printed plastic sheet 3 and the top layer 4 can be adhered onto the base 2 without wrinkles. A step of trimming and cutting may be applied before the step of pre-heating 34 to cut the combined bottom layer 1, the base 2, the printed plastic sheet 3 and the top layer 4 into pieces of same size. A step of overlapping and cooling is applied before the step of cutting such that the plastic bricks have stable physical and chemical characters which are benefit for cutting.

While we have shown and described the embodiment in accordance with the present invention, it should be clear to those skilled in the art that further embodiments may be made without departing from the scope of the present invention.

What is claimed is:

1. A plastic brick comprising:
a bottom layer and a base connected on the bottom layer, a printed plastic sheet connected on the base and a top layer connected on the printed plastic sheet, the bottom layer and the base being connected to each other by fusion, the bottom layer and the top layer having similar deformation efficiency.

2. The plastic brick as claimed in claim 1, wherein the printed plastic sheet has patterns printed thereon.

3. The plastic brick as claimed in claim 1, wherein the top layer has a serrated surface.

4. A method for making a plastic brick which includes a bottom layer with a base connected on the bottom layer, a printed plastic sheet connected on the base and a top layer connected on the printed plastic sheet, the method comprising the following steps:
step of material mixing: mixing material of the bottom layer and the base in two mixing devices;
step of plasticizing: stirring the material of the bottom layer in a stirring device and stirring the material of the base in a high speed stirring device to obtain semi-plasticized material;
step of extruding: sending the semi-plasticized material of the bottom layer and the semi-plasticized material of the base into two respective extruders to obtain two completely plasticized material;
step of extruding via T-shaped cavity: sending the two completely plasticized material into an extruder and extruded via a T-shaped cavity to combine the base and the bottom layer as a combined layer;
step of rolling: rolling the combined layer into desired thickness;
step of rolling and adhering: connecting the printed plastic sheet and the top layer to the combined layer by rolling and adhering;
step of cooling: cooling the combined bottom layer, the base, the printed plastic sheet and the top layer;
step of pre-heating: heating the combined bottom layer, the base, the printed plastic sheet and the top layer to have a softened top surface;
step of pressing: pressing a serrated surface on the combined bottom layer, the base, the printed plastic sheet and the top layer;
step of tempering: treating the combined bottom layer, the base, the printed plastic sheet and the top layer with tempering to release stress therein, and
step of cutting: cutting the tempered combined bottom layer, the base, the printed plastic sheet and the top layer to a complete plastic brick.

5. The method as claimed in claim 4 further comprising a step of heating before step of rolling and adhering.

6. The method as claimed in claim 4 further comprising a step of expanding to remove wrinkles on the printed plastic sheet and the top layer before the step of rolling and adhering.

7. The method as claimed in claim 4 further comprising a step of trimming and cutting before the step of pre-heating to cut the combined bottom layer, the base, the printed plastic sheet and the top layer into pieces of same size.

8. The method as claimed in claim 4 further comprising a step of overlapping and cooling before the step of cutting.
